(19) United States
(12) Patent Application Publication
(10) Pub. No.: US 2026/0127156 A1
(43) Pub. Date: May 7, 2026

(54) Systems and Methods for Data Processing for Cloud-Based Data Warehouses

(71) Applicant: Elevance Health, Inc., Indianapolis, IN (US)

(72) Inventors: Bharath SRINIVASAIAH, Richmond, VA (US); Umamaheswara Reddy KUDUMULA, Atlanta, GA (US); Krishna KANUMURI, Atlanta, GA (US); Sangameswara Rao GAVINI, Hyderabad (IN); Christopher ROPER, Weston, CT (US); Ian GUNN, Cranbrook, CA (US); Pisharath KRISHNAN, Frisco, TX (US); Anil LOOMBA, Iselin, NJ (US); Ashok CHENNURU, Powell, OH (US)

(21) Appl. No.: 19/379,201

(22) Filed: Nov. 4, 2025

Related U.S. Application Data
(60) Provisional application No. 63/715,933, filed on Nov. 4, 2024.

(51) Int. Cl. G06F 16/22; G06F 16/2455

(52) U.S. Cl. CPC G06F 16/2282; G06F 16/2456; G06F 16/24564

(57) ABSTRACT

Systems and methods are provided for processing data for cloud-based data warehousing. The method may receive a request to insert a large amount of data items into a table of a cloud-based database. The method may create a plurality of temporary tables in the cloud-based database in response to the request. The method may divide the large amount of data items into a plurality of sets of data items. The method may insert each set of data items of the plurality of sets of data items into a corresponding temporary table of the plurality of temporary tables. The method may merge the plurality of temporary tables into the table of the cloud-based database.

### RELATED APPLICATIONS

This application claims the benefit of, and priority to, U.S. Provisional Patent Application Ser. No. 63/715,933, filed Nov. 4, 2024, entitled “Systems and Methods for Dynamic Query Optimization for Distributed Computing Environments”, which is incorporated by reference herein in its entirety.

### TECHNICAL FIELD

The present disclosure generally relates to data processing and management within cloud-based data warehousing platforms, specifically focusing on cloud-based data warehouses' data processing capabilities.

### BACKGROUND

A data warehouse is an enterprise data platform used for the analysis and reporting of structured and semi-structured data from multiple data sources, such as point-of-sale transactions, marketing automation, customer relationship management, and more. Data warehouses include an analytical database and critical analytical components and procedures. They support ad hoc analysis and custom reporting, such as data pipelines, queries, and business applications. They can consolidate and integrate massive amounts of current and historical data in one place and are designed to give a long-range view of data over time. These data warehouse capabilities have made data warehousing a primary staple of enterprise analytics that help support informed business decisions.

A cloud-based data warehouse is a centralized database in a public cloud for storing, processing, integrating, and managing large volumes of structured and semi-structured data. Being a cloud-based data warehouse means that, instead of hosting physical servers and infrastructure on premises, everything happens in online—offsite servers take care of the heavy lifting, and users can access their data and analytics tools over the internet without the need for downloading or setting up any software or applications.

Cloud-based data warehouses are easier to set up compared to their traditional counterparts, which generally entails a complex setup. A cloud-based data warehouse stores, integrates, and processes large volumes of data from several sources, whether on-premises or on the internet. A cloud-based data warehouse is critical to make quick, data-driven decisions. It offers improved computational ability and simplified data management, allowing users to extract valuable insights from updated, accurate, and enriched data when needed.

While cloud-based data warehouses offer significant benefits, especially when it comes to scalability and flexibility, it has its own set of challenges and complexities. For example, some cloud-based data warehouses may impose limitations on the number of parallel operations performed on a table. These limitations can lead to bottlenecks and performance issues in data processing. Attempts to address the technical problem of limited parallel operations in cloud-based data warehouse involved manual monitoring and management of data processing to avoid exceeding the limit. However, such approach was suboptimal as it required significant time and effort, and did not provide a dynamic and automated solution to the problem. There is an increasing need for efficient data processing for cloud-based data warehouses.

### SUMMARY

The present disclosure aims to overcome the default limitation on the maximum parallel insert operations allowed on a table in cloud-based data warehouses by dynamically creating session-level temporary tables for insert operations. The chief objective of the present disclosure is to increase data processing capacity and optimize parallel insert operations, thereby reducing overall runtimes and getting data to business quicker. The techniques described herein improve the performance of cloud-based data warehouses while effectively managing data processing within the cloud-based data warehouses' limitations.

In one aspect, a method is provided for processing data for cloud-based data warehousing, according to some embodiments. The method may include receiving a request to insert a plurality of data items exceeding a predefined threshold into a table of a cloud-based database. The cloud-based database may impose a limit on the maximum number of parallel insert operations that can be performed on the table. The method may also include creating a plurality of temporary tables in the cloud-based database based on the amount of the plurality of data items. The method may also include dividing the plurality of data items into a plurality of sets of data items. The maximum size of each set of data items may be based on the number of processes writing to the table (e.g., to avoid queueing), with the goal of optimizing parallel insert operations within the cloud database's limitations, for example.

The method may also include inserting each set of data items of the plurality of sets of data items into a corresponding temporary table of the plurality of temporary tables. The method may also include merging the plurality of temporary tables into the table of the cloud-based database.

In some embodiments, the inserting of a first set of data items of the plurality of sets of data items into a first temporary table of the plurality of temporary tables may be performed in parallel with the inserting of a second set of data items of the plurality of sets of data items into a second temporary table of the plurality of temporary tables.

In some embodiments, the method may further include determining whether the number of parallel insert operations performed on the table is less than a threshold value. The threshold value may be less than or equal to the maximum number of parallel insert operations that can be performed on the table. The merging of the plurality of temporary tables into the table may be performed if the number of parallel insert operations performed on the table is determined to be less than the threshold value. In some embodiments, the method may further include waiting a time period before repeating the determining operation if the number of parallel insert operations performed on the table is determined to be greater than or equal to the threshold value.

In some embodiments, the method may further include identifying the particular number of temporary tables to be created. The identifying of the particular number of temporary tables to be created may include choosing a first number. The identifying of the particular number of temporary tables to be created may also include creating the first number of temporary tables in the cloud-based database. The identifying of the particular number of temporary tables to be created may also include dividing a collection of data items into the first number of sets of data items. The identifying of the particular number of temporary tables to be created may also include inserting each set of data items of the first number of sets of data items into a corresponding temporary table of the first number of temporary tables. The identifying of the particular number of temporary tables to be created may also include measuring a first time period needed for the inserting of the first number of sets of data items into the first number of temporary tables to complete. The identifying of the particular number of temporary tables to be created may also include choosing a second number that is different from the first number. The identifying of the particular number of temporary tables to be created may also include repeating the creating, dividing, inserting, and measuring operations based on the second number. The identifying of the particular number of temporary tables to be created may also include identifying the particular number of temporary tables to be created based on the measured time periods.

In some embodiments, a second time period may be measured for the inserting operation related to the second number. The identifying of the particular number of temporary tables to be created based on the measured time periods may include comparing the first time period with the second time period. The identifying of the particular number of temporary tables to be created based on the measured time periods may also include choosing the first number to be the particular number when the first time period is shorter than the second time period. The identifying of the particular number of temporary tables to be created based on the measured time periods may also include choosing the second number to be the particular number when the second time period is shorter than the first time period.

In another aspect, a computer system for processing data for cloud-based data warehousing is provided. The computer system may include one or more processors, a display, and a memory. The memory stores one or more programs configured for execution by the one or more processors. The one or more programs may include instructions for receiving a request to insert a plurality of data items exceeding a predefined threshold into a table of a cloud-based database. The cloud-based database may impose a limit on the maximum number of parallel insert operations that can be performed on the table. The one or more programs may include instructions for creating a plurality of temporary tables in the cloud-based database based on the amount of the plurality of data items. The one or more programs may include instructions for dividing the plurality of data items into the plurality of sets of data items. The one or more programs may include instructions for inserting each set of data items of the plurality of sets of data items into a corresponding temporary table of the plurality of temporary tables. The one or more programs may include instructions for merging the plurality of temporary tables into the table of the cloud-based database.

In some embodiments, the instructions for inserting a first set of data items of the plurality of sets of data items into a first temporary table of the plurality of temporary tables may be performed in parallel with the instructions for inserting a second set of data items of the plurality of sets of data items into a second temporary table of the plurality of temporary tables.

In some embodiments, the one or more programs may further include instructions for determining whether a number of parallel insert operations performed on the table is less than a threshold value. The threshold value may be less than or equal to the maximum number. The instructions for merging the plurality of temporary tables into the table may be performed if the number of parallel insert operations performed on the table is determined to be less than the threshold value. In some embodiments, the one or more programs may further include instructions for waiting a time period before repeating the determining operation if the number of parallel insert operations performed on the table is determined to be greater than or equal to the threshold value.

In some embodiments, the one or more programs may further include instructions for identifying the particular number of temporary tables to be created. The instructions for identifying the particular number of temporary tables to be created may include instructions for choosing a first number. The instructions for identifying the particular number of temporary tables to be created may also include instructions for creating the first number of temporary tables in the cloud-based database. The instructions for identifying the particular number of temporary tables to be created may also include instructions for dividing a collection of data items into the first number of sets of data items. The instructions for identifying the particular number of temporary tables to be created may also include instructions for inserting each set of data items of the first number of sets of data items into a corresponding temporary table of the first number of temporary tables. The instructions for identifying the particular number of temporary tables to be created may also include instructions for measuring a first time period needed for the inserting of the first number of sets of data items into the first number of temporary tables to complete. The instructions for identifying the particular number of temporary tables to be created may also include instructions for choosing a second number that is different from the first number. The instructions for identifying the particular number of temporary tables to be created may also include instructions for repeating the creating, dividing, inserting, and measuring operations based on the second number. The instructions for identifying the particular number of temporary tables to be created may also include instructions for identifying the particular number of temporary tables to be created based on the measured time periods.

In some embodiments, a second time period may be measured for the inserting operation related to the second number. The instructions for identifying the particular number of temporary tables to be created based on the measured time periods may include instructions for comparing the first time period with the second time period. The instructions for identifying the particular number of temporary tables to be created based on the measured time periods may also include instructions for choosing the first number to be the particular number if the first time period is shorter than the second time period. The instructions for identifying the particular number of temporary tables to be created based on the measured time periods may also include instructions for choosing the second number to be the particular number if the second time period is shorter than the first time period.

### BRIEF DESCRIPTION OF THE DRAWINGS

FIG. 1 illustrates an example of distributed data warehouse system that may provide data management services to clients.

FIG. 2 shows several flowcharts of a method for processing data for cloud-based data warehousing according to some embodiments of the present disclosure.

FIG. 3 shows a flowchart of a method for processing data for cloud-based data warehousing according to some embodiments of the present disclosure.

FIG. 4 shows a flowchart of a method for processing data for cloud-based data warehousing according to some embodiments of the present disclosure.

FIG. 5 shows a flowchart of a method for determining the number of temporary tables to create for a table in the cloud-based data warehouse according to some embodiments of the present disclosure.

FIGS. 6A and 6B illustrate an example of processing data for cloud-based data warehousing according to some embodiments of the present disclosure.

FIG. 7 illustrates an example of a computer system on which embodiments described herein may be executed.

Like reference numerals refer to corresponding parts throughout the drawings.

### DETAILED DESCRIPTION

Reference will now be made to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

The development of the solution in the present disclosure is a response to the challenges of limited number of parallel insert operations into a table posed by some cloud-based data warehouses. For example, some cloud-based data warehouses limit the maximum number of parallel insert operations on a table to be 40. This limitation can lead to bottlenecks and performance issues in data processing.

The present disclosure aims to provide a dynamic and efficient approach to managing parallel insert operations within cloud-based data warehouses. The present disclosure leverages the capability to dynamically create session-level temporary tables for each insert operation, optimizing data processing by ensuring the maximum number of parallel insert operations is always maintained, without causing bottlenecks or performance issues. This addresses the technical challenge of managing parallel insert operations effectively within the constraints of the cloud-based data warehouse's default offerings.

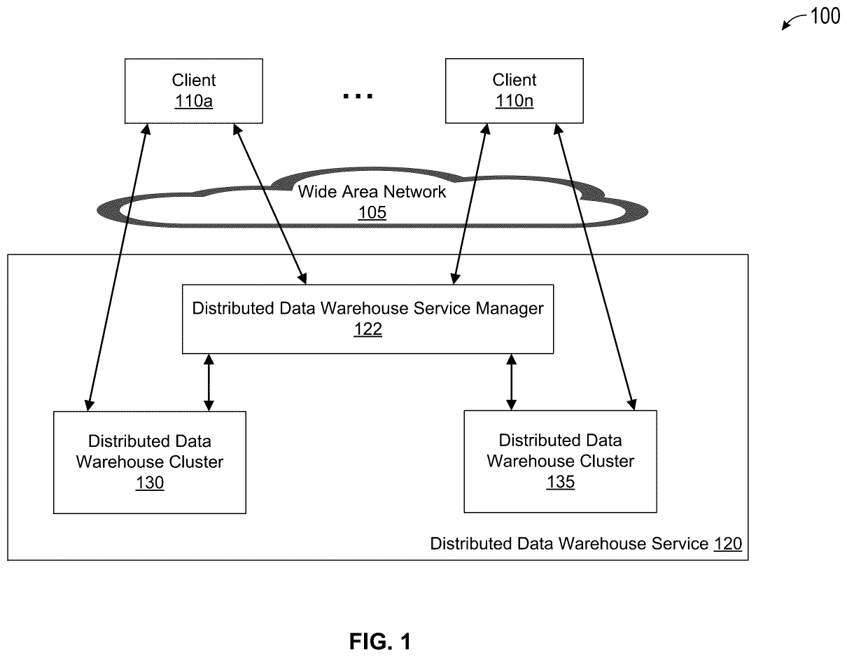

In some embodiments, various clients (or customers, organizations, entities, or users) may wish to store and manage data using a data management service. FIG. 1 illustrates an example of distributed data warehouse system 100 that may provide data management services to clients. Specifically, data warehouse clusters may respond to store requests (e.g., to write data into storage) or queries for data (e.g., such as a Server Query Language request (SQL) for select data), along with many other data management or storage services.

Multiple users or clients may access a data warehouse cluster to obtain data warehouse services. In some embodiments, clients may include users, client applications, and/or data warehouse service subscribers. In one example, each of the clients 110a through 110n is able to access data warehouse cluster 130 and 135 respectively in the distributed data warehouse service 120. Distributed data warehouse cluster 130 and 135 may include two or more nodes on which data may be stored on behalf of the clients 110a through 110n who have access to those clusters.

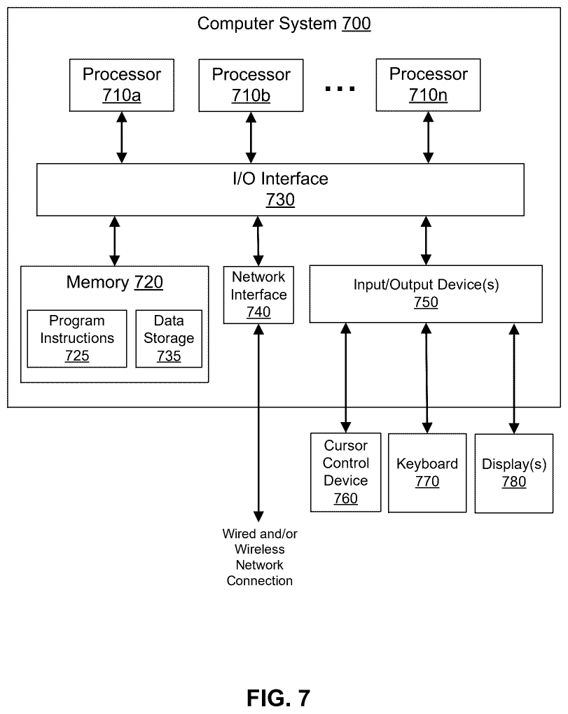

A client, such as one of clients 110a through 110n, may communicate with a data warehouse cluster 130 or 135 via a desktop computer, laptop computer, tablet computer, personal digital assistant, mobile device, server, or any other computing system or other device, such as computer system 700 described below with regard to FIG. 7, configured to send requests to the data warehouse clusters 130 and 135, and/or receive responses from the distributed data warehouse clusters 130 and 135. Such requests, for example, may be formatted as a message that includes parameters and/or data associated with a particular function or service offered by a data warehouse cluster. Such a message may be formatted according to a particular markup language such as Extensible Markup Language (XML), and/or may be encapsulated using a protocol such as Simple Object Access Protocol (SOAP). Application programmer interfaces (APIs) may be implemented to provide standardized message formats for clients, such as for when clients are communicating with distributed data warehouse service manager 122.

Clients 110a through 110n may communicate with distributed data warehouse clusters 130 and 135, hosted by distributed data warehouse service 120 using a variety of different communication methods, such as over Wide Area Network (WAN) 105 (e.g., the Internet). Private networks, intranets, and other forms of communication networks may also facilitate communication between clients and data warehouse clusters. A client may assemble a message including a request and convey the message to a network endpoint (e.g., a Uniform Resource Locator (URL)) corresponding to the data warehouse cluster). For example, a client 110a may communicate via a desktop computer running a local software application, such as a web-client, that is configured to send hypertext transfer protocol (HTTP) requests to data warehouse cluster 130 over WAN 105. Responses or other data sent to clients may be formatted in similar ways.

In at least some embodiments, a distributed data warehouse service 120 may host distributed data warehouse clusters, such as clusters 130 and 135. The distributed data warehouse service 120 may provide network endpoints to the storage clients 110a to 110n of the clusters which allow the clients 110a through 110n to send requests and other messages directly to a particular cluster. As noted above, network endpoints, for example may be a particular network address, such as a URL, which points to a particular cluster. For example, client 110a may be given the network endpoint “http://mycluster.com” to send various request messages to. Multiple storage clients (or users of a particular storage client) may be given a network endpoint for a particular cluster. Various security features may be implemented to prevent unauthorized users from accessing the clusters. Conversely, a client may be given network endpoints for multiple clusters.

Distributed data warehouse clusters, such as data warehouse cluster 130 and 135, may be made up of one or more nodes. These clusters may include different numbers of nodes. A node may be a server, desktop computer, laptop, or, more generally any other computing device, such as those described below with regard to computer system 700 in FIG. 7. In some embodiments, the number of nodes in a data warehouse cluster may be modified, such as by a cluster scaling request. Clusters may be configured to receive requests and other communications over WAN 105 from storage clients, such as clients 110a through 110n. A cluster may be configured to receive requests from multiple clients via the network endpoint of the cluster.

In some embodiments, distributed data warehouse service 120 may be implemented as part of a web service that allows users to set up, operate, and scale a data warehouse in a cloud computing environment. The data warehouse clusters hosted by the web service may provide an enterprise-class database query and management system that allows users to scale the clusters, such as by sending a cluster scaling request to a cluster control interface implemented by the web-service. Scaling clusters may allow users of the web service to perform their data warehouse functions, such as fast querying capabilities over structured data, integration with various data loading and ETL (extract, transform, and load) tools, client connections with best-in-class business intelligence (BI) reporting, data mining, and analytics tools, and optimizations for very fast execution of complex analytic queries such as those including multi-table joins, sub-queries, and aggregation, more efficiently.

In various embodiments, distributed data warehouse service 120 may provide clients (e.g., subscribers to the data warehouse service provided by the distributed data warehouse system) with data storage and management resources that may be created, configured, managed, scaled, and terminated in response to requests from the storage client. For example, in some embodiments, distributed data warehouse service 120 may provide clients of the system with data warehouse clusters composed of virtual compute nodes. These virtual compute nodes may be nodes implemented by virtual machines, such as hardware virtual machines, or other forms of software implemented to simulate hardware configurations. Virtual nodes may be configured to perform the same tasks, functions, and/or services as nodes implemented on physical hardware.

Distributed data warehouse service 120 may be implemented by a large collection of computing devices, such as customized or off-the-shelf computing systems, servers, or any other combination of computing systems or devices, such as the various types of devices described below with regard to FIG. 7. Distributed data warehouse service manager may control different subsets of these computing devices 122. Distributed data warehouse service manager 122, for example, may provide a cluster control interface to clients, such as clients 110a through 110n, or any other clients or users who wish to interact with the distributed data warehouse clusters managed by the distributed data warehouse manager 122, which in this example illustration would be data warehouse clusters 130 and 135. For example, distributed data warehouse service manager 122 may generate one or more graphical user interfaces (GUIs) for storage clients, which may then be utilized to select various control functions offered by the control interface for the data warehouse clusters hosted in the distributed data warehouse service 120.

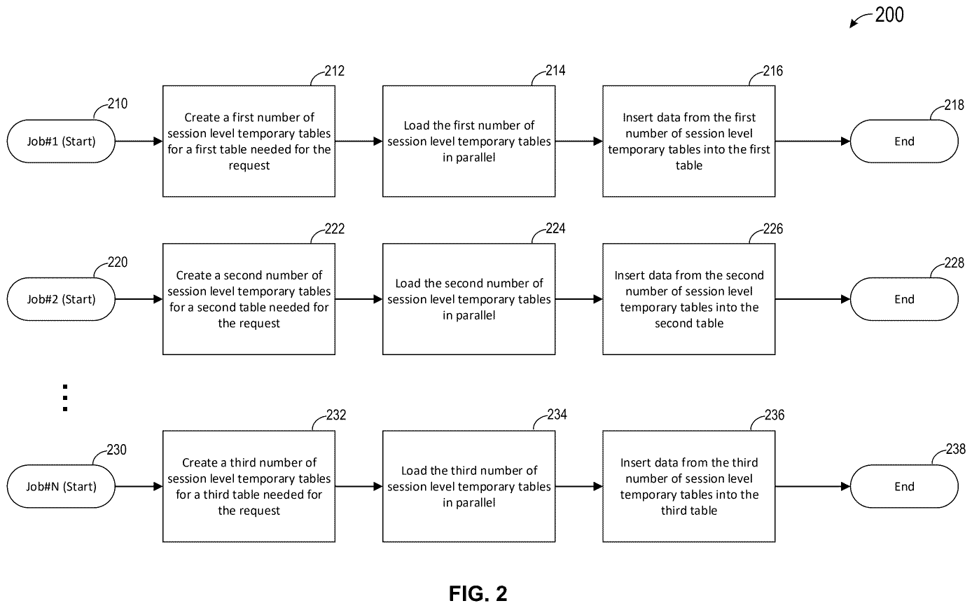

FIG. 2 shows several flowcharts of a method 200 for processing data for cloud-based data warehousing according to some embodiments of the present disclosure. The method 200 aims to overcome the default limitation on the maximum parallel insert operations allowed on a table in cloud-based data warehouses by dynamically creating session-level temporary tables for insert operations. One main objective of the method 200 for at least one embodiment is to increase data processing capacity and optimize parallel insert operations, using parallel jobs processing, thereby reducing overall runtimes and getting data to business quicker.

The method 200 may be performed by one or more computing devices (e.g., computer system 700 described below with regard to FIG. 7). The method 200 may include N jobs (e.g., Job #1, Job #2, . . . Job #N, where N is an integer) associated with a request. In some embodiments, these jobs may be performed in parallel. In some embodiments, some of these jobs may be performed sequentially. The method 200 may be performed as a result of a request to insert a large amount of data into one or more tables of the cloud-based data warehouse.

In some embodiments, Job #1 may start at 210. At 212, Job #1 may create a first number of session level temporary tables for a first final table in the cloud-based data warehouse needed for the request. At 214, Job #1 may load the first number of session level temporary tables in parallel. In some embodiments, loading the first number of session level temporary tables in parallel may mean at least one of (i) performing multiple insert operations in parallel on each session level temporary table and (ii) the loading of each session level temporary table being in parallel with the loading of other session level temporary tables. In some embodiments, the data to be loaded may go through an ETL process. At 216, Job #1 may insert data from the first number of session level temporary tables into the first final table. Job #1 ends at 218.

In some embodiments, Job #2 may start at 220. At 222, Job #2 may create a second number of session level temporary tables for a second final table in the cloud-based data warehouse needed for the request. At 224, Job #2 may load the second number of session level temporary tables in parallel. In some embodiments, loading the second number of session level temporary tables in parallel may mean at least one of (i) performing multiple insert operations in parallel on each session level temporary table and (ii) the loading of each session level temporary table being in parallel with the loading of other session level temporary tables. In some embodiments, the data to be loaded may go through an ETL process. At 226, Job #2 may insert data from the second number of session level temporary tables into the second final table. Job #2 ends at 228.

In some embodiments, Job #N may start at 230. At 232, Job #N may create a third number of session level temporary tables for a third final table in the cloud-based data warehouse needed for the request. At 234, Job #N may load the third number of session level temporary tables in parallel. In some embodiments, loading the third number of session level temporary tables in parallel may mean at least one of (i) performing multiple insert operations in parallel on each session level temporary table and (ii) the loading of each session level temporary table being in parallel with the loading of other session level temporary tables. In some embodiments, the data to be loaded may go through an ETL process. At 236, Job #N may insert data from the third number of session level temporary tables into the third final table. Job #N ends at 238.

In some embodiments, at least two of the first number, the second number, and the third number may be the same. In some embodiments, the first number, the second number, and the third number may be different. In some embodiments, at least two of the first final table, the second final table, and the third final table may be the same table. In some embodiments, the first final table, the second final table, and the third final table may be different tables. The method 200 improves the performance of cloud-based data warehouses while effectively managing data processing within the cloud-based data warehouses' limitations.

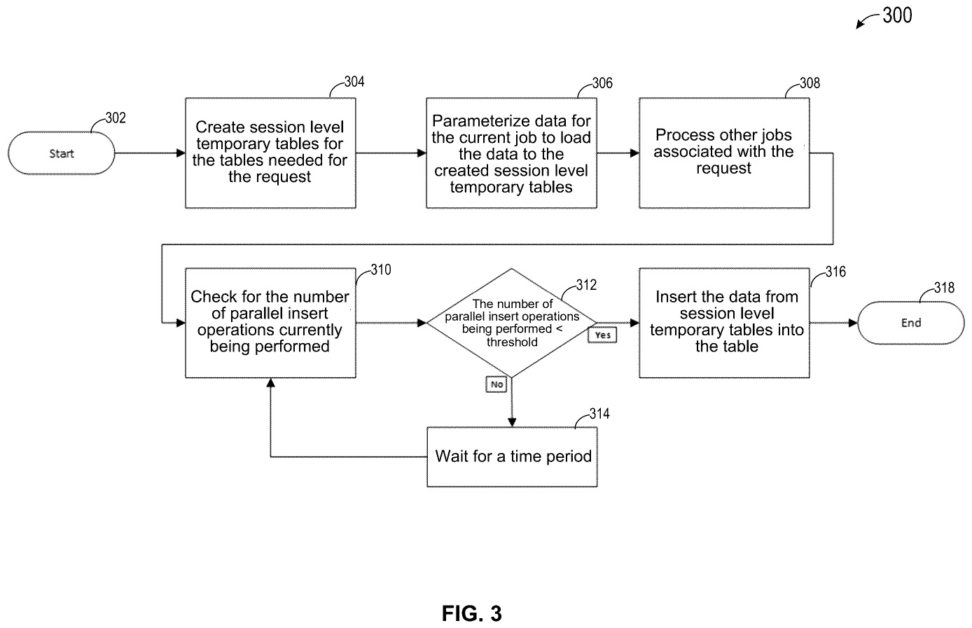

FIG. 3 shows a flowchart of a method 300 for processing data for cloud-based data warehousing according to some embodiments of the present disclosure. The method 300 can operate in conjunction with method 200 to overcome the default limitation on the maximum parallel insert operations allowed on a table in cloud-based data warehouses by dynamically creating session-level temporary tables for insert operations. The method 300 may be performed by one or more computing devices (e.g., computer system 700 described below with regard to FIG. 7). In some embodiments, the method 300 may correspond to the method 200 described above with reference to FIG. 2.

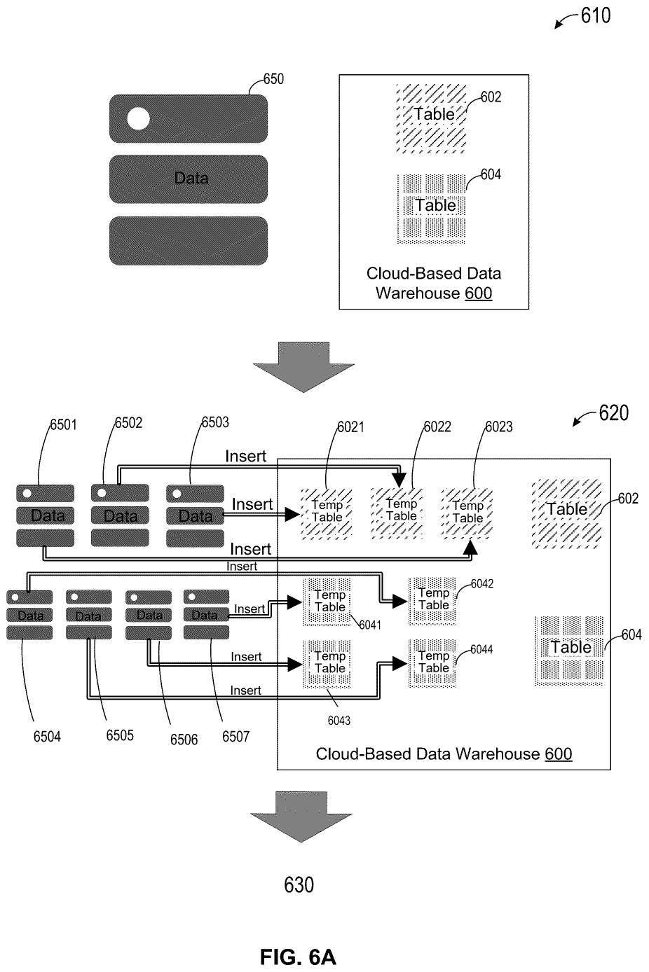

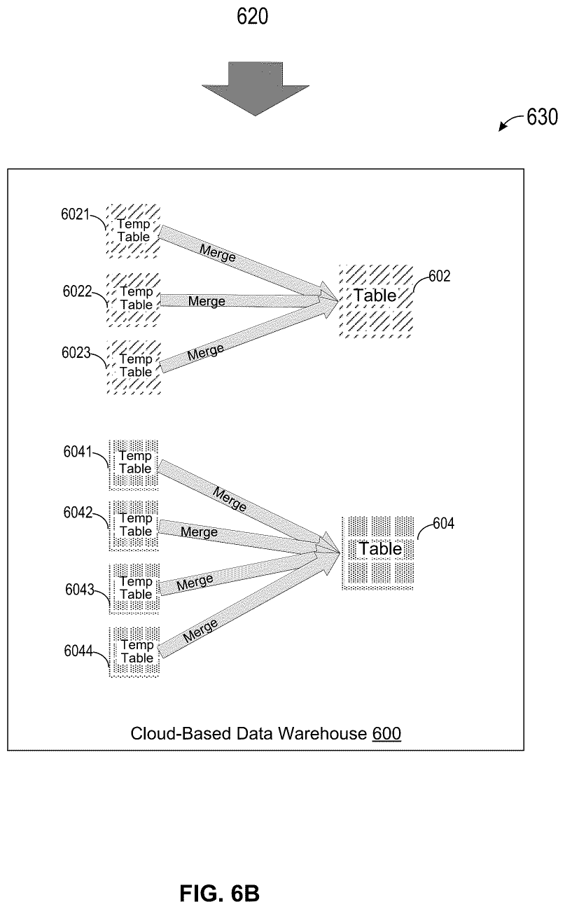

In some embodiments, the method 300 may start at 302 in response to a request made to the cloud-based data warehouse. The request may include inserting a large amount of data into one or more tables of the cloud-based data warehouse. The large amount of data may be related to the business operation of an entity. FIGS. 6A and 6B illustrate an example of processing data for cloud-based data warehousing according to some embodiments of the present disclosure. As illustrated in FIG. 6A below, at 610, a request may be made to insert a large amount of data 650 into tables 602 and 604 of the cloud-based data warehouse 600. The data 650 may be any data that is useful for the business operation of a particular entity.

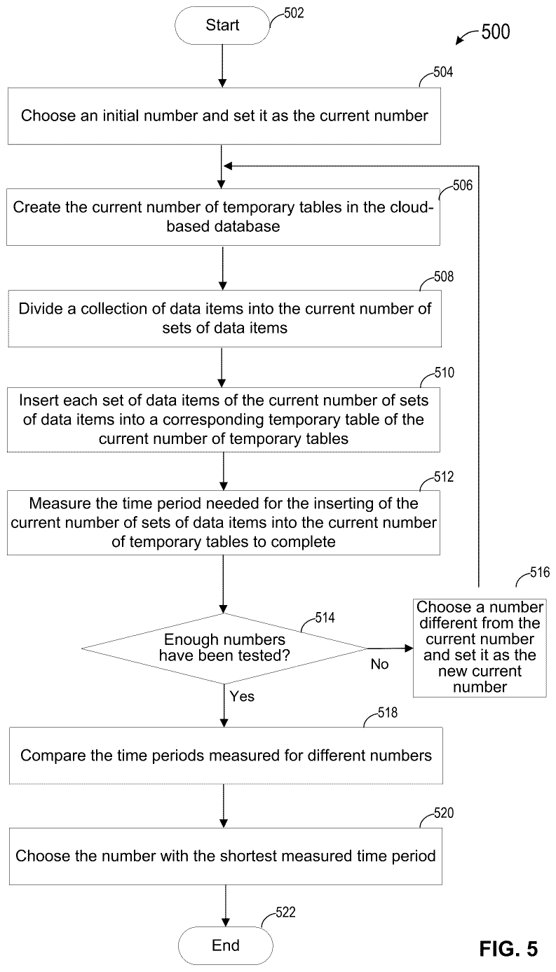

At 304, the method 300 may create session level temporary tables for the tables needed for the request. Session level temporary tables are created to overcome the limitations on the number of parallel operations performed on a table imposed by some cloud-based data warehouses, thus improving the level of parallelism in the processing of the data. In some embodiments, session level temporary tables are duplicate copies of the table in the cloud-based data warehouse. Each session level temporary table may be a copy of a portion of the table in the cloud-based data warehouse. FIG. 5 below will further describe how to determine the number of temporary tables to be created. As illustrated in FIG. 6A below, at 620, temporary tables 6021, 6022, 6023 may be created for the table 602; and temporary tables 6041, 6042, 6043, and 6044 may be created for the table 604.

At 306, the method 300 may parameterize data for the current job to load the data to the created session level temporary tables. Parameterizing data for the current job may refer to the process of organizing and structuring data in a tabular format where different aspects or variables (parameters) of the data are stored in rows and columns to make data more manageable, searchable, and analyzable. Parameterizing data for the current job may include dividing data into multiple data sets, each of which corresponding to one of the created session level temporary tables. As illustrated in FIG. 6A below, at 620, the large amount of data 650 may be divided into data sets 6501, 6502, 6503, 6504, 6505, 6506, and 6507. The datasets 6501, 6502, and 6503 may correspond to temporary tables 6023, 6022, and 6021, respectively. The datasets 6504, 6505, 6506, and 6507 may correspond to temporary tables 6042, 6044, 6043, and 6041, respectively.

The method 300 may load the data into the session level temporary tables in parallel. In some embodiments, loading the data into the session level temporary tables in parallel may mean at least one of (i) performing multiple insert operations in parallel on each session level temporary table and (ii) the loading of each session level temporary table being in parallel with the loading of other session level temporary tables. For example, as illustrated in FIG. 6A below, at 620, data in datasets 6501, 6502, and 6503 may be loaded into temporary tables 6023, 6022, and 6021, respectively, in parallel; data in datasets 6504, 6505, 6506, and 6507 may be loaded into temporary tables 6042, 6044, 6043, and 6041, respectively, in parallel. The data items in each dataset are inserted into the corresponding temporary table in parallel. For example, data items in dataset 6501 are inserted into temporary table 6023 in parallel. Furthermore, the loading of a temporary table (e.g., temporary table 6021) is performed in parallel with the loading of other temporary tables (e.g., 6022, 6023, 6041, 6042, 6043, and 6044).

At 308, the method 300 may process other jobs associated with the request. For example, as illustrated in FIG. 2 above, the current job may be Job #1, and other jobs may be Job #2, . . . Job #N. In some embodiments, other jobs may be processed in parallel with the current job to improve data processing speed. In some embodiments, other jobs may be processed after the current job is processed if there are some kinds of dependency between other jobs and the current job.

At 310, the method 300 may check for the number of parallel insert operations currently being performed on a table in the cloud-based data warehouse. This is to ensure that the maximum parallel insert operations allowed on the table imposed by the operator of the cloud-based data warehouse will not be exceeded. Without making such an inquiry, if the maximum parallel insert operations allowed on the table is exceeded due to the operations of the method 300, the overall efficiency of data processing may be hampered and/or additional cost may be incurred.

At 312, the method 300 may determine whether the number of parallel insert operations currently being performed on the table is less than a threshold. In some embodiments, the threshold is less than or equal to the maximum number of parallel insert operations allowed on the table imposed by the operator of the cloud-based data warehouse. The threshold is set to ensure that the maximum parallel insert operations allowed on the table will not be exceeded. If the number of parallel insert operations currently being performed on the table is greater than or equal to the threshold, the method 300 may wait (at 314) for a time period (e.g., 30 seconds). In some embodiments, the length of the time period is pre-determined or configured manually. In some embodiments, the length of the time period may be adjusted dynamically based on the current load of the cloud-based data warehouse. The method 300 may then loop back to 310. If the number of parallel insert operations currently being performed on the table is less than the threshold, the method 300 may insert (at 316) the data from session level temporary tables associated with the table into the table. For examples, as illustrated in FIG. 6B, at 630, data from temporary tables 6021, 6022, and 6023 are inserted into table 602 by merging temporary tables 6021, 6022, and 6023 into table 602; data from temporary tables 6041, 6042, 6043, and 6044 are inserted into table 604 by merging temporary tables 6041, 6042, 6043, and 6044 into table 604. Since such a merge operation of bulk data is much faster than inserting data items individually, significant time can be saved while effectively managing data processing within the cloud-based data warehouse's limitations.

In some embodiments, the method may include handling scenarios where the data items in different sets have varying sizes or complexities. The method may include, for example, obtaining the original size of the table. The method 300 may then use this information to select the size of the cluster to execute on. The method 300 may also use this information to determine the approximate number of temporary tables that many be needed. After processing of the temporary tables, in some embodiments, the method 300 may include merging all the temporary tables into the original table. In some embodiments, this is a kill-n-fill process, which may include wiping out or deleting the old version and replace it with the merged temporary tables. Merging may be performed across database management systems. Some embodiments may automatically detect failure during any steps of the method 300, may stop one or more jobs, close one or more connections (e.g., connections to Snowflake), identify a cause for the failure, fix the cause, and/or restart the method 300 from the beginning.

The method 300 then ends at 318.

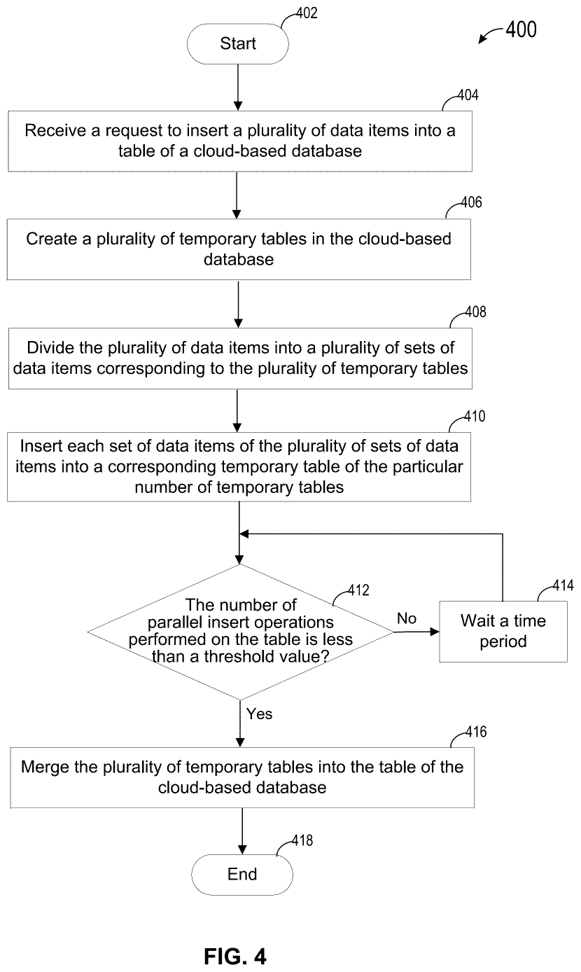

FIG. 4 shows a flowchart of a method 400 for processing data for cloud-based data warehousing according to some embodiments of the present disclosure. The method 400 may be performed by one or more computing devices (e.g., computer system 700 described below with regard to FIG. 7). In some embodiments, the method 400 may correspond to a job of the method 200 described above with reference to FIG. 2. In some embodiments, the method 400 may correspond to the method 300 described above with reference to FIG. 3. In some embodiments, the cloud-based database may set a limit on the maximum number of parallel insert operations allowed to be performed on the table.

In some embodiments, the method 400 may start at 302 in relation to a cloud-based database. At 404, the method 400 may receive a request to insert a plurality of data items into a table of the cloud-based database. The plurality of data items may exceed a predefined threshold to qualify as a large amount of data items. As illustrated in FIG. 6A below, at 610, a request may be made to insert a large amount of data 650 into tables 602 and 604 of the cloud-based data warehouse 600. The data 650 may be any data that is useful for the business operation of a particular entity.

At 406, the method 400 may create a plurality of temporary tables in the cloud-based database based on the amount of the plurality of data items. The plurality of temporary tables are created to overcome the limitations on the number of parallel operations performed on a table imposed by the cloud-based database, thus improving the level of parallelism in the processing of the data. In some embodiments, the plurality of temporary tables are duplicate copies of the table in the cloud-based data warehouse. In some embodiments, each temporary table is a copy of a portion of the table. For example, as illustrated in FIG. 6A below, at 620, temporary tables 6021, 6022, 6023 may be created for the table 602.

At 408, the method 400 may divide the plurality of data items into a plurality of sets of data items corresponding to the plurality of temporary tables. As illustrated in FIG. 6A below, at 620, The large amount of data 650 may be divided into data sets 6501, 6502, 6503, 6504, 6505, 6506, and 6507. The datasets 6501, 6502, and 6503 may correspond to temporary tables 6023, 6022, and 6021, respectively.

At 410, the method 400 may insert each set of data items of the plurality of sets of data items into a corresponding temporary table of the plurality of temporary tables. For example, as illustrated in FIG. 6A below, at 620, data items in datasets 6501, 6502, and 6503 may be inserted into temporary tables 6023, 6022, and 6021, respectively. The method 400 may insert the data items into the temporary tables in parallel. In some embodiments, inserting the data items into the temporary tables in parallel may mean at least one of (i) performing multiple insert operations in parallel on each temporary table and (ii) the inserting of each temporary table being in parallel with the inserting of other temporary tables. For example, in some embodiments, the inserting of a first set of data items of the plurality of sets of data items into a first temporary table of the plurality of temporary tables is performed in parallel with the inserting of a second set of data items of the plurality of sets of data items into a second temporary table of the plurality of temporary tables.

At 412, the method 400 may determine whether the number of parallel insert operations performed on the table is less than a threshold value. In some embodiments, the threshold value is less than or equal to the maximum number of parallel insert operations allowed on the table imposed by the operator of the cloud-based database. The threshold value is set to ensure that the maximum parallel insert operations allowed on the table will not be exceeded. If the number of parallel insert operations performed on the table is greater than or equal to the threshold value, the method 400 may wait (at 414) for a time period (e.g., 30 seconds). The method 400 may then loop back to 412. If the number of parallel insert operations performed on the table is less than the threshold value, the method 400 may merge (at 416) the plurality of temporary tables into the table of the cloud-based database. For examples, as illustrated in FIG. 6B, at 630, data items from temporary tables 6021, 6022, and 6023 are merged into table 602. Since such a merge operation of bulk data is much faster than inserting data items individually, significant time can be saved while effectively managing data processing within the cloud-based database's limitations.

The method 400 then ends at 418. In some embodiments, all the temporary tables created get deleted automatically once the method 400 completes.

In some embodiments, the method 400 may merge the plurality of temporary tables into the table in batches. That is, the method 400 may divide the plurality of temporary tables into a set of groups and merge the temporary tables into the table one group at a time (e.g., in one insert/merge operation). In some embodiments, the number of temporary tables in each group may be determined by dividing the number of temporary tables by a predetermined number (e.g., 10) and round it off.

For example, if the number of temporary tables is 20, the group size would be 20/10=2. Thus, the merging of the 20 temporary tables into the table would be merging two temporary tables at a time (e.g., in one insert/merge operation).

Various embodiments provided in the present disclosure may overcome the default limitation on the number of parallel insert operations allowed on a table in a cloud-based data warehouse, thereby increasing data processing capacity. Some embodiments optimize data processing by ensuring that the maximum number of parallel insert operations is always maintained, without causing any bottlenecks or performance issues. Some embodiments provide a simple and efficient solution to manage parallel inserts, reducing the time and effort required to monitor and manage data processing. In some embodiments, session-level temporary tables may be dynamically created for each insert operation, allowing for dynamic load balancing beyond the limitation of maximum number of parallel insert operations imposed by the cloud-based data warehouse's default offerings.

Various embodiments represent an improvement to the function of the cloud-based database by allowing for increased parallel insert operations beyond the default limit. Various embodiments also demonstrate a meaningful application of dynamic load balancing to enhance data processing capacity. In some experiments, hundreds of query requests per second on a database caused queuing at 60% cluster utilization. The current usage was monitored. A conventional database/system was unable to add another node. On the other hand, the techniques described herein bypassed the individual cluster queuing issue by allocating a new named cluster. During the monitoring of this process, execution latency dropped by 25-40% (depending on size of queries/cluster used). The monitoring continued on the new cluster and repeated as the cluster filled up. Then as the cluster was no longer needed, once the queries were finished, that named cluster was freed. In this way, data processing time can be reduced, and significant cost saving can be achieved.

FIG. 5 shows a flowchart of a method 500 for determining the number of temporary tables to create for a table in the cloud-based data warehouse according to some embodiments of the present disclosure. The method 500 may be performed by one or more computing devices (e.g., computer system 700 described below with regard to FIG. 7). In some embodiments, the method 500 may be used to determine the number of temporary tables to create for the method 200, 300, or 400 described above with reference to FIG. 2, 3, or 4, respectively.

In some embodiments, the method 500 may start at 502. At 504, the method 500 may choose an initial number and set it as the current number. At 506, the method 500 may create the current number of temporary tables for a table in the cloud-based database. At 508, the method 500 may divide a collection of data items into the current number of sets of data items.

At 510, the method 500 may insert each set of data items of the current number of sets of data items into a corresponding temporary table of the current number of temporary tables. The method 500 may insert the data items into the temporary tables in parallel. In some embodiments, inserting the data items into the temporary tables in parallel may mean at least one of (i) performing multiple insert operations in parallel on each temporary table and (ii) the inserting of each temporary table being in parallel with the inserting of other temporary tables. For example, in some embodiments, the inserting of a first set of data items of the current number of sets of data items into a first temporary table of the current number of temporary tables is carried out in parallel with the inserting of a second set of data items of the current number of sets of data items into a second temporary table of the current number of temporary tables.

At 512, the method 500 may measure a time period needed for the inserting of the current number of sets of data items into the current number of temporary tables to complete. At 514, the method 500 may determine whether enough different numbers have been tested to obtain time periods needed for the inserting of the collection of data items into the number of temporary tables. If it is determined that the number of different numbers tested are not yet enough, the method 500 may choose (at 516) a number different from the current number and set the number as the new current number. The method 500 may then loop back to 506. If it is determined that the number of different numbers tested are enough, the method 500 may compare (at 518) the time periods measured for different numbers. At 510, the method 500 choose the number with the shortest measured time period. The method 500 then ends at 522.

For example, the method 500 may initially choose X and set it as the current number of temporary tables for a table in the cloud-based data warehouse. The method 500 then runs parallel processes (each process processes different set of data) as per the X number of temporary tables chosen initially and collect the run statistics like how much time each temporary table took to finish loading its data and how long it takes to finish all temporary tables processes.

The method 500 may also run parallel processes as per the X−5 number of temporary tables and collect the run statistics like how much time each temporary table took to finish loading its data and how long it takes to finish all temporary tables processes.

The method 500 may also run parallel processes as per the X−10 number of temporary tables and collect the run statistics like how much time each temporary table took to finish loading its data and how long it takes to finish all temporary tables processes.

The method 500 may also run parallel processes as per the X+5 number of temporary tables and collect the run statistics like how much time each temporary table took to finish loading its data and how long it takes to finish all temporary tables processes.

The method 500 may also run parallel processes as per the X+10 number of temporary tables and collect the run statistics like how much time each temporary table took to finish loading its data and how long it takes to finish all temporary tables processes.

In some embodiments, if the run statistics collected for X−10 giving better performance (reduction in run times) compared to the run statistics collected for X−5, the method 500 may further try with X−15 as well. If the run statistics collected for X−10 increases the run time compared to the run statistics collected for X−5, the method 500 may stops going further in that direction.

In some embodiments, if the run statistics collected for X+10 giving better performance (reduction in run times) compared to the run statistics collected for X+5, the method 500 may further try with X+15 as well. If the run statistics collected for X+10 increases the run time compared to the run statistics collected for X+5, the method 500 may stops going further in that direction.

After having multiple iterations of the above, using the run time statistics collected, the method 500 choses the number that gives better performance (in terms of better run times).

FIGS. 6A and 6B illustrate an example of processing data for cloud-based data warehousing according to some embodiments of the present disclosure. As illustrated in FIG. 6A, at 610, a request may be made to insert a large amount of data 650 into tables 602 and 604 of the cloud-based data warehouse 600. The data 650 may be any data that is useful for the business operation of a particular entity.

At 620, temporary tables 6021, 6022, 6023 may be created for the table 602; and temporary tables 6041, 6042, 6043, and 6044 may be created for the table 604. In some embodiments, temporary tables may be duplicate copies of the tables in the cloud-based data warehouse 600. In some embodiments, each temporary table may be a copy of a portion of a table in the cloud-based data warehouse 600.

Also at 620, the large amount of data 650 may be divided into data sets 6501, 6502, 6503, 6504, 6505, 6506, and 6507. The datasets 6501, 6502, and 6503 may correspond to temporary tables 6023, 6022, and 6021, respectively. The datasets 6504, 6505, 6506, and 6507 may correspond to temporary tables 6042, 6044, 6043, and 6041, respectively. Data items in datasets 6501, 6502, and 6503 may be inserted into temporary tables 6023, 6022, and 6021, respectively. Data items in datasets 6504, 6505, 6506, and 6507 may be inserted into temporary tables 6042, 6044, 6043, and 6041, respectively. The data items in each dataset may be inserted into the corresponding temporary table in parallel. For example, data items in dataset 6501 may be inserted into temporary table 6023 in parallel. Furthermore, the loading of a temporary table (e.g., inserting data items in data set 6503 into temporary table 6021) may be performed in parallel with the loading of other temporary tables.

As illustrated in FIG. 6B, at 630, data from temporary tables 6021, 6022, and 6023 are merged into table 602; data from temporary tables 6041, 6042, 6043, and 6044 are merged into table 604. Since such a merge operation of bulk data is much faster than inserting data items individually, significant time can be saved while effectively managing data processing within the cloud-based data warehouse's limitations.

The example of processing data for cloud-based data warehousing in FIGS. 6A and 6B may overcome the default limitation on the number of parallel insert operations allowed on a table in a cloud-based data warehouse, thereby increasing data processing capacity. Some embodiments optimize data processing by ensuring that the maximum number of parallel insert operations is always maintained, without causing any bottlenecks or performance issues. Some embodiments provide a simple and efficient solution to manage parallel inserts, reducing the time and effort required to monitor and manage data processing. In some embodiments, session-level temporary tables may be dynamically created for each insert operation, allowing for dynamic load balancing beyond the limitation of maximum number of parallel insert operations imposed by the cloud-based data warehouse's default offerings. Various embodiments represent an improvement to the function of the cloud-based database by allowing for increased parallel insert operations beyond the default limit. Various embodiments also demonstrate a meaningful application of dynamic load balancing to enhance data processing capacity. As a result, data processing time can be reduced, and significant cost saving can be achieved.

Embodiments described herein may be executed on one or more computer systems, which may interact with various other devices. One such computer system is illustrated by FIG. 7. In different embodiments, computer system 700 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. Display(s) 780 may include standard computer monitor(s) and/or other display systems, technologies or devices. In at least some implementations, the input/output devices 750 may also include a touch-or multi-touch enabled device such as a pad or tablet via which a user enters input via a stylus-type device and/or one or more digits. In some embodiments, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, processors 710 may be general-purpose or embedded processors implementing any of a variety of instruction set architectures (ISAs), such as the x86, PowerPC, SPARC, or MIPS ISAs, or any other suitable ISA. In multiprocessor systems, each of processors 710 may commonly, but not necessarily, implement the same ISA.

In some embodiments, at least one processor 710 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s).

System memory 720 may be configured to store program instructions and/or data accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for scaling computing clusters in distributed systems as described herein are shown stored within system memory 720 as program instructions 725 and data storage 735, respectively. In other embodiments, program instructions and/or data may be received, sent or stored upon different types of computer-accessible media or on similar media separate from system memory 720 or computer system 700. Generally speaking, a computer-accessible medium may include storage media or memory media such as magnetic or optical media, e.g., disk or CD/DVD-ROM coupled to computer system 700 via I/O interface 730. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 740.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. In addition, in some embodiments some or all of the functionality of I/O interface 730, such as an interface to system memory 720, may be incorporated directly into processor 710.

Network interface 740 may be configured to allow data to be exchanged between computer system 700 and other devices attached to a network, such as other computer systems, or between nodes of computer system 700. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or retrieving data by one or more computer system 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

As shown in FIG. 7, memory 720 may include program instructions 725, configured to provide time-based item recommendations for a scheduled delivery orders as described herein, and data storage 735, comprising various data accessible by program instructions 725. In one embodiment, program instructions 725 may include software elements of embodiments as described herein and as illustrated in the Figures. Data storage 735 may include data that may be used in embodiments. In other embodiments, other or different software elements and data may be included.

Those skilled in the art will appreciate that computer system 700 is merely illustrative and is not intended to limit the scope of the stereo drawing techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. For example, leader nodes within a data warehouse system may present data storage services and/or database services to clients as web services. In some embodiments, a web service may be implemented by a software and/or hardware system designed to support interoperable machine-to-machine interaction over a network. A web service may have an interface described in a machine-processable format, such as the Web Services Description Language (WSDL). Other systems may interact with the web service in a manner prescribed by the description of the web service's interface. For example, the web service may define various operations that other systems may invoke, and may define a particular application programming interface (API) to which other systems may be expected to conform when requesting the various operations.

In various embodiments, a web service may be requested or invoked through the use of a message that includes parameters and/or data associated with the web services request. Such a message may be formatted according to a particular markup language such as Extensible Markup Language (XML), and/or may be encapsulated using a protocol such as Simple Object Access Protocol (SOAP). To perform a web services request, a web services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for processing data for cloud-based data warehousing, comprising:
receiving a request to insert a plurality of data items exceeding a predefined threshold into a table of a cloud-based database, wherein the cloud-based database imposes a limit on a maximum number of parallel insert operations that can be performed on the table;
identifying a particular number of temporary tables to be created, wherein the identifying of the particular number of temporary tables to be created comprises:
choosing a first number;
creating the first number of temporary tables in the cloud-based database;
dividing a collection of data items into the first number of sets of data items;
inserting each set of data items of the first number of sets of data items into a corresponding temporary table of the first number of temporary tables;
measuring a first time period needed for the inserting of the first number of sets of data items into the first number of temporary tables to complete;
choosing a second number that is different from the first number;
repeating the creating, dividing, inserting, and measuring operations based on the second number, wherein a second time period is measured for the inserting operation related to the second number;
identifying the particular number of temporary tables to be created based on the measured time periods, wherein the identifying of the particular number of temporary tables to be created based on the measured time periods comprises:
comparing the first time period with the second time period;
choosing the first number to be the particular number when the first time period is shorter than the second time period; and
choosing the second number to be the particular number when the second time period is shorter than the first time period;
creating the particular number of temporary tables in the cloud-based database;
dividing the plurality of data items into the particular number of sets of data items, wherein a maximum size of each set of data items is based on a number of processes writing to the table;
inserting each set of data items of the particular number of sets of data items into a corresponding temporary table of the particular number of temporary tables, wherein the inserting of a first set of data items of the particular number of sets of data items into a first temporary table of the particular number of temporary tables is performed in parallel with the inserting of a second set of data items of the particular number of sets of data items into a second temporary table of the particular number of temporary tables;
determining whether a number of parallel insert operations performed on the table is less than a threshold value, wherein the threshold value is less than or equal to the maximum number;
merging the particular number of temporary tables into the table of the cloud-based database when the number of parallel insert operations performed on the table is determined to be less than the threshold value; and
waiting a time period before repeating the determining operation when the number of parallel insert operations performed on the table is determined to be greater than or equal to the threshold value.

2. A method for processing data for cloud-based data warehousing, comprising:
receiving a request to insert a plurality of data items exceeding a predefined threshold into a table of a cloud-based database, wherein the cloud-based database imposes a limit on a maximum number of parallel insert operations that can be performed on the table;
creating a plurality of temporary tables in the cloud-based database based on an amount of the plurality of data items;
dividing the plurality of data items into a plurality of sets of data items, wherein a maximum size of each set of data items is based on a number of processes writing to the table;
inserting each set of data items of the plurality of sets of data items into a corresponding temporary table of the plurality of temporary tables; and
merging the plurality of temporary tables into the table of the cloud-based database.

3. The method of claim 2, wherein the inserting of a first set of data items of the plurality of sets of data items into a first temporary table of the plurality of temporary tables is performed in parallel with the inserting of a second set of data items of the plurality of sets of data items into a second temporary table of the plurality of temporary tables.

4. The method of claim 2, further comprising:
determining whether a number of parallel insert operations performed on the table is less than a threshold value, wherein the threshold value is less than or equal to the maximum number, wherein the merging of the plurality of temporary tables into the table is performed when the number of parallel insert operations performed on the table is determined to be less than the threshold value; and
waiting a time period before repeating the determining operation when the number of parallel insert operations performed on the table is determined to be greater than or equal to the threshold value.

5. The method of claim 4, further comprising identifying a particular number of temporary tables to be created, wherein the identifying of the particular number of temporary tables to be created comprises:
choosing a first number;
creating the first number of temporary tables in the cloud-based database;
dividing a collection of data items into the first number of sets of data items;
inserting each set of data items of the first number of sets of data items into a corresponding temporary table of the first number of temporary tables;
measuring a first time period needed for the inserting of the first number of sets of data items into the first number of temporary tables to complete;
choosing a second number that is different from the first number;
repeating the creating, dividing, inserting, and measuring operations based on the second number; and
identifying the particular number of temporary tables to be created based on the measured time periods.

6. The method of claim 5, wherein a second time period is measured for the inserting operation related to the second number, wherein the identifying of the particular number of temporary tables to be created based on the measured time periods comprises:
comparing the first time period with the second time period;
choosing the first number to be the particular number when the first time period is shorter than the second time period; and
choosing the second number to be the particular number when the second time period is shorter than the first time period.

7. A computer system for processing data for cloud-based data warehousing, comprising:
one or more processors;
a display; and
a memory, wherein the memory stores one or more programs configured for execution by the one or more processors, and the one or more programs comprising instructions for:
receiving a request to insert a plurality of data items exceeding a predefined threshold into a table of a cloud-based database, wherein the cloud-based database imposes a limit on a maximum number of parallel insert operations that can be performed on the table;
creating a plurality of temporary tables in the cloud-based database based on an amount of the plurality of data items;
dividing the plurality of data items into a plurality of sets of data items, wherein a maximum size of each set of data items is based on a number of processes writing to the table;
inserting each set of data items of the plurality of sets of data items into a corresponding temporary table of the plurality of temporary tables; and
merging the plurality of temporary tables into the table of the cloud-based database.

8. The computer system of claim 7, wherein instructions for inserting a first set of data items of the plurality of sets of data items into a first temporary table of the plurality of temporary tables is performed in parallel with instructions for inserting a second set of data items of the plurality of sets of data items into a second temporary table of the plurality of temporary tables.

9. The computer system of claim 7, wherein the one or more programs further comprise instructions for:
determining whether a number of parallel insert operations performed on the table is less than a threshold value, wherein the threshold value is less than or equal to the maximum number, wherein the instructions for merging the plurality of temporary tables into the table is performed when the number of parallel insert operations performed on the table is determined to be less than the threshold value; and
waiting a time period before repeating the determining operation when the number of parallel insert operations performed on the table is determined to be greater than or equal to the threshold value.

10. The computer system of claim 9, wherein the one or more programs further comprise instructions for identifying a particular number of temporary tables to be created, wherein the instructions for identifying the particular number of temporary tables to be created comprises instructions for:
choosing a first number;
creating the first number of temporary tables in the cloud-based database;
dividing a collection of data items into the first number of sets of data items;
inserting each set of data items of the first number of sets of data items into a corresponding temporary table of the first number of temporary tables;
measuring a first time period needed for the inserting of the first number of sets of data items into the first number of temporary tables to complete;
choosing a second number that is different from the first number;
repeating the creating, dividing, inserting, and measuring operations based on the second number; and
identifying the particular number of temporary tables to be created based on the measured time periods.

11. The computer system of claim 10, wherein a second time period is measured for the inserting operation related to the second number, wherein the instructions for identifying the particular number of temporary tables to be created based on the measured time periods comprise instructions for:
comparing the first time period with the second time period;
choosing the first number to be the particular number when the first time period is shorter than the second time period; and
choosing the second number to be the particular number when the second time period is shorter than the first time period.
